(19) United States
(12) Patent Application Publication
(10) Pub. No.: US 2006/0280146 A1
(43) Pub. Date: Dec. 14, 2006

(54) Handover support for multiple types of traffic

(75) Inventors: Rajeev Koodli, Sunnyvale, CA (US); Charles Perkins, Saratoga, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/372,045

(22) Filed: Mar. 10, 2006

Related U.S. Application Data
(60) Provisional application No. 60/690,126, filed on Jun. 14, 2005.

(51) Int. Cl. H04Q 7/00

(52) U.S. Cl. 370/331

(57) ABSTRACT

The present invention relates to a mobile node, router device and method of providing to a first type of traffic an enhanced handover function specified for a second type of traffic, wherein a predetermined set of handover destination address parameters is derived from a protocol signaling related to the second type of traffic. This derived set of handover destination address parameters is then used to generate for the first type of traffic a new destination address in accordance with the second type of traffic, and a binding update is initiated for binding at least one original destination address of the first type of traffic to the generated new destination address of the second type of traffic. Thus, handover support can be provided for the first kind of traffic without requiring a dedicated handover protocol for the first kind of traffic.

### CROSS-REFERENCE TO RELATED APPLICATION

This application claims priority of U.S. Provisional Patent Application Ser. No. 60/690,126, filed on Jun. 14, 2005. The subject matter of this earlier filed application is hereby incorporated by reference

### FIELD OF THE INVENTION

The present invention relates to a system and method of providing to a first type of traffic, e.g. IPv4 traffic, an enhanced handover function specified for a second type of traffic, e.g. IPv6 traffic.

### BACKGROUND OF THE INVENTION

Mobility support for Internet devices is quite important, since mobile computing and communication is getting more widespread. There are already first-generation products of cellular phones offering IP (Internet Protocol) services based on WAP (Wireless Application Protocol) or GPRS (General Packet Radio Services), and their number will increase rapidly. Cellular devices of the 3^{rd} generation will be packet switched devices along with the traditional circuit switched devices. Therefore, IP services on 3^{rd} generation cellular devices will be an integral part of the future communication services.

Today, several problems confront seamless roaming on the Internet. The problems start if somebody disconnects his or her mobile device from the Internet in order to connect it elsewhere. Normally, (s)he would not be able to continue communication until he configures the system with a new IP address, the correct net mask and a new default router.

This problem is based on the routing mechanisms which are used in the Internet. IP addresses define a kind of topological relation between the linked computers. Today's versions of Internet protocols assume implicitly that a node has always the same point of attachment to the Internet. Additionally, the node's IP address identifies the link on which the node resides. If a node moves without changing its IP address, there is no information in its network address about the new point of attachment to the Internet.

To support mobile devices, which dynamically change their access points to the Internet, the Internet Engineering Task Force (IETF) has standardized a protocol supporting mobile Internet devices, called Mobile IP. There are two variations of Mobile IP, namely Mobile IPv4, based on IPv4 (Internet Protocol version 4), and Mobile IPv6, based on IPv6 (Internet Protocol version 6). The latter one is described in IETF specification RFC 3775. Further information on the IPv6 can be obtained from IETF specification RFC 2460, 1998.

Mobile IPv6 allows an IPv6 host to leave its home subnet while transparently maintaining all of its present connections and remaining reachable to the rest of the Internet. This is realized in Mobile IPv6 by identifying each node by its static home address, regardless of its current point of attachment to the Internet. While a mobile node is away from home it sends information about its current location to a home agent on its home link. The home agent intercepts packets addressed to the mobile node and tunnels them to the mobile node's present location. This mechanism is completely transparent for all layers above IP, e.g. for TCP (Transmit Control Protocol), UDP (User Datagram Protocol) and of course for all applications. Therefore, domain name server (DNS) entries for a mobile node refer to its home address and don't change if the mobile node changes its Internet access point. In fact, Mobile IPv6 influences the routing of packets but is independent of the routing protocol itself.

The solution given by Mobile IPv6 consists of creating a so-called care-of address (CoA) whenever a node changes its point of attachment to the Internet. The care-of-address is an IP address associated with a mobile node while visiting a foreign link. The subnet prefix of this IP address is a foreign subnet prefix. Among the multiple care-of-addresses that a mobile node may have at a time (e.g. with different subnet prefixes), the one registered with the mobile nodes home agent is called its “primary” care-of-address. A care-of-address can be derived from the receipt of router advertisements in a so-called “stateless address auto-configuration” as described in S. Thomson and T. Narten, “IPv6 Stateless Address Auto-Configuration”, IETF specification RFC 2462, 1998, or can be assigned by a DHCP (Dynamic Host Configuration Protocol) server in a so-called “stateful address auto-configuration”. Mobile nodes are always identified by their (static) home address regardless of their current point of attachment to the Internet. While away from home each mobile node has an additional (temporary) address which identifies its current location. Thus, basically messages that arrive at the original home address are redirected or tunneled to the care-of-address.

Furthermore, Mobile IPv6 Fast Handover protocol has been proposed as a way to minimize interruption in service experienced by a Mobile IPv6 node as it changes its point of attachment to the Internet. Without such a mechanism, a mobile node cannot send or receive packets from the time that it disconnects from one point of attachment in one subnet to the time it registers a new care-of address from the new point of attachment in a new subnet. Such an interruption would be unacceptable for real-time services such as Voice-over-IP. It is noted that there may be other sources of service interruption that may be “built-in” to the link-layer handoff.

The basic idea behind a Mobile IPv6 fast handover is to leverage information from the link-layer technology to either predict or rapidly respond to a handover event. This allows IP connectivity to be restored at the new point of attachment sooner than would otherwise be possible. By tunneling data between the old and new access routers, it is possible to provide IP connectivity in advance of actual Mobile IP registration with the home agent or a correspondent node (which is a network node with which a mobile node is communicating). This removes such Mobile IP registration, which may require time-consuming Internet round-trips, from the critical path before real-time service is re-established.

Typically, mobile nodes and their access routers possess dual-stack capability, i.e. they can use both IPv4 and IPv6 capabilities. The protocol specified in “Mobile IPv6 Fast Handovers”, draft-ietf-mipshop-fast-mip6-03.txt (IETF draft) is for supporting IPv6 traffic. The protocol specified in K. El-malki (Editor), “Low-latency handover for Mobile IPv4” is for supporting IPv4 traffic. When a Mobile Node handovers from a subnet to another, routing support is necessary to allow its traffic (such as VoIP, video, e-mail, etc.) to follow the Mobile Node to its new subnet. However, traffic continuity of IPv4 traffic during a Mobile Node's handover using the IPv6 Fast Handover protocol requires separate protocol option(s).

### SUMMARY OF THE INVENTION

It is therefore an object of the present invention to provide a method and system for enabling fast handover for mobile nodes, while supporting several types of traffic, i.e. both IPv4 and IPv6 traffic. This object is achieved by a method of providing to a first type of traffic an enhanced handover function specified for a second type of traffic, said method comprising the steps of:
deriving a predetermined set of handover destination address parameters from a protocol signaling related to said second type of traffic;
using said derived set of handover destination address parameters to generate for said first type of traffic a new destination address in accordance with said second type of traffic; and
initiating a binding update for binding at least one original destination address of said first type of traffic to said generated new destination address of said second type of traffic.

Furthermore, the above object is achieved by a mobile node for providing to a first type of traffic an enhanced handover function specified for a second type of traffic, said mobile node comprising:
deriving a predetermined set of handover destination address parameters from a protocol signaling related to said second type of traffic;
generating based on said derived set of handover destination address parameters a new destination address in accordance with said second type of traffic; and
initiating a binding update for binding at least one original destination address of said first type of traffic to said generated new destination address of said second type of traffic.

Additionally, the above object is achieved by a router device for providing to a first type of traffic an enhanced handover function specified for a second type of traffic, said router device comprising:
extracting means for extracting from a binding update message at least one original destination address of said first type of traffic an a new destination address of said second type of traffic; and
creating means for creating a new routing table entry for said at least one original destination address to point to said new destination address.

Accordingly, handover support is provided for the first type of traffic without requiring a handover protocol for the first type of traffic. As use can be made of an existing handover protocol of the second type of traffic, simultaneous handover support can be provided for both types of traffic.

As an example, the first type of traffic may be or may comprise IPv4 traffic and the second type of traffic may be or may comprise IPv6 traffic. Then, the enhanced handover function may be or may comprise an IPv6 fast handover function. The predetermined set of handover destination address parameters may comprise an IPv6 address, a MAC address and an IPv6 subnet prefix of a new access router.

A new routing table entry may be created for the at least one original destination address to point to the new destination address. This at least one original destination address may comprise a destination address of the first type of traffic and a previous destination address of the second type of traffic pointing to a previous access router. Specifically, the new routing table entry may comprise a flag information for encapsulating an arriving first type of traffic of the original destination address in a packet of the second type of traffic addressed to the new destination address. The new routing table entry may comprise a flag information for encapsulating an arriving second type of traffic of the previous destination address in a packet of the second type of traffic addressed to the new destination address. The original destination address may comprises a Mobile IP home address or a Mobile IP co-located care of address.

The initiating step may be performed by using a fast binding update message comprising the original destination address and the new destination address. If, however, the network or a certain network area or domain does not support the second type of traffic, a tunneling function of the first type of traffic is used to carry the second type of traffic.

The above functional steps can be implemented either by concrete hardware units or by software routines. The software routines may be comprised in a computer program product with code means configured to execute the above method steps when run on a computer device of the mobile node.

Further advantageous developments and modifications can be gathered from the dependent claims.

### BRIEF DESCRIPTION OF THE DRAWINGS

In the following, the present invention will be described in greater detail on the basis of a preferred embodiment with reference to the accompanying drawings in which:

FIG. 1 shows a schematic network architecture indicating a schematic signaling for obtaining IPv4 and IPv6 connectivity according to the preferred embodiment;

FIG. 2 shows a schematic network architecture indicating a schematic signaling for handover support of IPv4 and IPv6 traffic according to the preferred embodiment;

FIG. 3 shows a schematic diagram indicating arrangement of an alternate care of address; and

FIG. 4 shows schematic block diagrams of a mobile node and a router device according to the preferred embodiment.

### DESCRIPTION OF THE PREFERRED EMBODIMENT

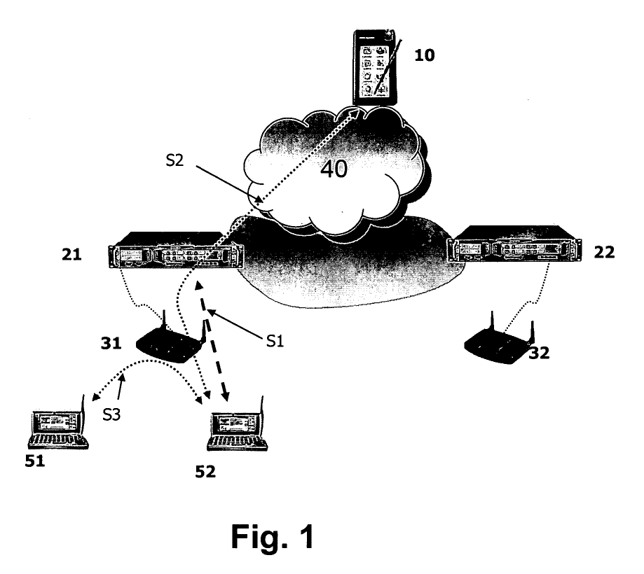

The preferred embodiment will now be described on the basis of a IPv6 architecture as shown in FIG. 1.

According to FIG. 1, the IPv6 architecture includes three specific network elements, mobile nodes 51, 52 which can change their point of attachment, access points 31, 32, and access routers 21, 22 for establishing a link via an IP network 40, such as the Internet, to a correspondent node 10, e.g. another party's terminal device.

According to the preferred embodiment, IPv4 traffic continuity can be supported during a mobile node's handover using the IPv6 Fast Handover protocol, which specifies protocol mechanics for supporting IPv6 traffic when a mobile node initiates handover from an access router to another. In particular, the preferred embodiment serves to achieve traffic continuity of IPv4 traffic (as well as IPv6 traffic) without requiring a separate protocol.

In the following, it shall be assumed that the mobile nodes 51, 52 and their access routers 21, 22 possess dual-stack (i.e., both IPv4 and IPv6) capability.

When the mobile node 52 establishes link connectivity on a subnet, it proceeds to configure an IPv4 address and an IPv6 address (called Previous-IPv6-CoA in the above protocol “Mobile IPv6 Fast Handovers”) on its Previous Access Router (PAR) 21 via the current access point 31, as indicated in FIG. 1.

In step S1 of FIG. 1, the mobile node 52 obtains from its PAR 21 IPv4 and IPv6 addresses and learns a neighborhood map of access points and access routers. Subsequently, it runs some applications. For instance, it might run a VoIPv4 application (e.g. packet (voice) stream) with the remote correspondent node 10 on the Internet 40 (step S2), and an IPv6 chat application with another mobile node 51 on its subnet via the current access point 31 (step S3).

It is supposed that the mobile node 52 then decides to handover to a New Access Router (NAR) 22. To achieve this, the mobile node 52 follows the above protocol to learn the IPv6 address and MAC address of the NAR 22 and the IPv6 subnet prefix. Then, the mobile node 52 formulates a new IPv6 care-of address “New-IPv6-CoA” using the subnet information of the NAR 22.

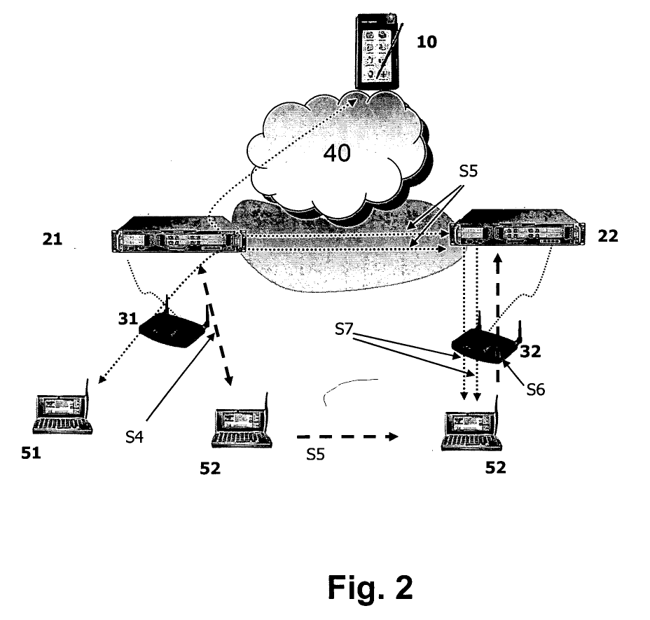

FIG. 2 shows signaling steps for handover support for IPv4 and IPv6 traffic in the architecture of FIG. 1. In step S4, the mobile node 52 sends a new Fast Binding Update (FBU) message to the PAR 21 in which it includes its IPv4 address in addition to a previous IPv6 care-of address “Previous-IPv6-CoA”, and requests the PAR 21 to bind both its IPv4 and IPv6 addresses to the new IPv6 address “New-IPv6-CoA”. The PAR 21 creates new route table entries for the IPv4 address and previous IPv6 address “Previous-IPv6-CoA” to point to the new IPv6 address “New-IPv6-CoA” generated or formulated by the mobile node 52. The new route table entries may also include a flag to encapsulate the arriving traffic for the IPv4 address in an IPv6 packet whose destination is set to new IPv6 address “New-IPv6-CoA”. Similarly, the new route table entries may include a flag for encapsulating the traffic for the previous IPv6 address “Previous-IPv6-CoA” to the new IPv6 address “New-IPv6-CoA”. Once the route table entries are created, all arriving traffic for the two addresses valid on the PAR's subnet are tunnelled to the new IPv6 address “New-IPv6-CoA” as re-routed IPv6 and/or IPv4 packet streams and the mobile node 52 can initiate fast handover to the new location (step S5).

In step S6 of FIG. 2, the mobile node 52 announces attachment to the new access router, i.e. NAR 22, via a new access point 32, and in response thereto the NAR 22 forwards the re-routed packet streams to the mobile node 52 step S7.

The proposed fast handover support works equally well when the mobile node 52 is using Mobile IPv4 and/or Mobile IPv6 protocol. It is assumed that the mobile node 52 uses the Mobile IPv4 protocol while exchanging VoIPv4 traffic with its correspondent 10. There are two scenarios based on the IPv4 address that the mobile node 52 can use. In the first scenario, when the mobile node 52 is using the co-located CoA, it owns that (topologically correct) IPv4 address. The packets from the correspondent node 10 to the home address of mobile node 52 are tunnelled by the Home Agent to the co-located CoA. In this case, the IPv4 address used in the FBU packet is the co-located CoA. And, the PAR 21 establishes a route table entry for the co-located CoA to refer to the new IPv6 address “New-IPv6-CoA”. In the second scenario, the mobile node 52 uses an address configured on the Foreign Agent as its CoA. In the preferred embodiment, the Foreign Agent (FA) is the same as the PAR 21. In this case, the mobile node 52 uses its home address as the IPv4 address in the FBU packet. Subsequently, the PAR 21 (or FA) updates the route table entry for the home address to refer to the new IPv6 address “New-IPv6-CoA”. In both the scenarios, arriving packets (i.e., either for the co-located CoA or for the home address) are encapsulated and sent to the new IPv6 address “New-IPv6-CoA”.

As the above protocol “Mobile IPv6 Fast Handovers” is designed to work with Mobile IPv6, no special considerations apply when a mobile node uses the Mobile IPv6 protocol.

The IPv6 traffic between the two access routers 21, 22 can be carried using IPv6-in-IPv4 tunnelling, which corresponds to step S5 in FIG. 2, in networks that do not support an IPv6 routing infrastructure. A known method such as 6-to-4 tunneling, as specified in the IETF specification RFC 3056, can be used for this purpose.

The proposed fast handover support mechanism can be implemented as an extension to the IPV6 Fast Handover protocol. Then, a new Alternate CoA option for IPv4 can be defined to be carried in the Fast Binding Update (FBU) message. This allows the PAR 21 to bind the IPv4 address to the new IPv6 address “New-IPv6-CoA”.

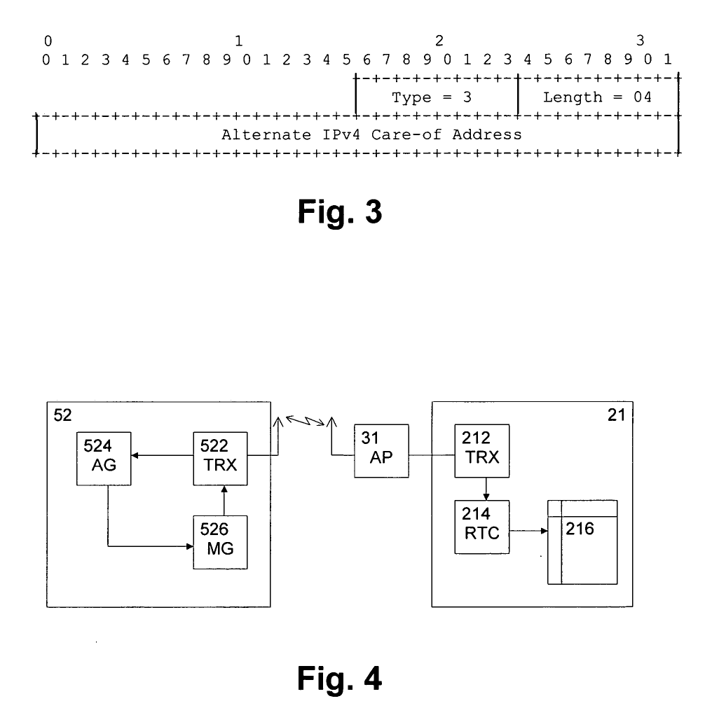

FIG. 3 shows a schematic diagram indicating the new Alternate IPv4 CoA option which is carried in the FBU message. This new option “Alternate IPv4 Care-of Address” can be of type “3” and length “4”.

FIG. 4 shows schematic block diagrams of relevant functions of the mobile node 52 and the PAR 21. Both mobile node 52 and PAR 21 comprise a transceiver unit 522 and 212, respectively, for transmitting and receiving data to/from the intermediate access point 31. At the mobile node 52, subnet information of the NAR 22 received from the PAR 21 is processed in an address generator function or unit 524 so as to formulate or generate the new IPv6 address “New-IPv6-CoA”. This new IPv6 address is supplied to a message generating function or unit 526, which generates the FBU message by adding the original IPv4 and previous IPv6 addresses and the new IPv6 address “New-IPv6-CoA”.

The FBU message is transmitted via the TRX unit 522 and the access point 31 to the PAR 21 where the addresses are extracted by a route table control function 214 which generates the above mentioned new entries to the route table or routing table 216. Thereby, IPv4 and IPv6 traffic is re-routed to the NAR 22.

Hence, the proposed method provides the advantage of handover support for IPv4 traffic without requiring a handover protocol for IPv4. Since it makes use of an existing handover protocol for IPv6, the method provides simultaneous handover support for IPv4 and IPv6 traffic.

It is noted, that the present invention is not restricted to the specific preferred embodiment described above, but can be used in any packet data network having different types of traffic with different protocol types. Any kind of suitable address parameter(s) can be used to generate the new destination address to be added to the binding update. The preferred embodiment may thus vary within the scope of the attached claims.

1. A method of providing, to a first type of traffic, an enhanced handover function specified for a second type of traffic, said method comprising the steps of:
a) deriving a predetermined set of handover destination address parameters from a protocol signaling related to said second type of traffic;
b) using said derived set of handover destination address parameters to generate, for said first type of traffic, a new destination address in accordance with said second type of traffic; and
c) initiating a binding update for binding at least one original destination address of said first type of traffic to said generated new destination address of said second type of traffic.

2. A method according to claim 1, wherein said first type of traffic comprises IPv4 traffic and said second type of traffic comprises IPv6 traffic.

3. A method according to claim 2, wherein said enhanced handover function comprises an IPv6 fast handover function.

4. A method according to claim 1, wherein said predetermined set of handover destination address parameters comprises an IPv6 address, a MAC address and an IPv6 subnet prefix of a new access router.

5. A method according to claim 1, further comprising the step of creating a new routing table entry for said at least one original destination address to point to said new destination address.

6. A method according to claim 5, wherein said at least one original destination address comprises a destination address of said first type of traffic and a previous destination address of said second type of traffic pointing to a previous access router.

7. A method according to claim 5, wherein said new routing table entry comprises a flag information for encapsulating an arriving first type of traffic of said at least one original destination address in a packet of said second type of traffic addressed to said new destination address.

8. A method according to claim 6, wherein said new routing table entry comprises a flag information for encapsulating an arriving second type of traffic of said previous destination address in a packet of said second type of traffic addressed to said new destination address.

9. A method according to claim 1, wherein said at least one original destination address comprises one of a Mobile IP home address and a Mobile IP co-located care of address.

10. A method according to claim 9, wherein said initiating step is performed by using a fast binding update message comprising said at least one original destination address and said new destination address.

11. A method according to claim 1, further comprising the step of carrying said second type of traffic by using a tunneling function of said first type of traffic in networks that do not support said second type of traffic.

12. A computer program product, embodied on a computer readable medium, for executing the following steps when run on a computer device:
a) deriving a predetermined set of handover destination address parameters from a protocol signaling related to said second type of traffic;
b) using said derived set of handover destination address parameters to generate, for said first type of traffic, a new destination address in accordance with said second type of traffic; and
c) initiating a binding update for binding at least one original destination address of said first type of traffic to said generated new destination address of said second type of traffic.

13. A mobile node for providing, to a first type of traffic, an enhanced handover function specified for a second type of traffic, said mobile node comprising:
a) deriving means for deriving a predetermined set of handover destination address parameters from a protocol signaling related to said second type of traffic;
b) generating means for generating, based on said derived set of handover destination address parameters, a new destination address in accordance with said second type of traffic; and
c) initiating means for initiating a binding update for binding at least one original destination address of said first type of traffic to said generated new destination address of said second type of traffic.

14. A mobile node according to claim 13, wherein said first type of traffic comprises IPv4 traffic and said second type of traffic comprises IPv6 traffic.

15. A mobile node according to claim 13, wherein said enhanced handover function comprises an IPv6 fast handover function.

16. A mobile node according to claim 13, wherein said predetermined set of handover destination address parameters comprises an IPv6 address, a MAC address and an IPv6 subnet prefix of a new access router.

17. A mobile node according to claim 13, wherein said initiating means is configured to use a fast binding update message comprising said at least one original destination address and said new destination address.

18. A router device for providing, to a first type of traffic, an enhanced handover function specified for a second type of traffic, said router device comprising:
a) extracting means for extracting, from a binding update message, at least one original destination address of said first type of traffic and a new destination address of said second type of traffic; and
b) creating means for creating a new routing table entry for said at least one original destination address to point to said new destination address.

19. A router device according to claim 18, wherein said at least one original destination address comprises a destination address of said first type of traffic and a previous destination address of said second type of traffic pointing to a previous access router.

20. A router device according to claim 18, wherein said creating means is configured to add, to said new routing table entry, a first flag information for encapsulating an arriving first type of traffic of said at least one original destination address in a packet of said second type of traffic addressed to said new destination address.

21. A router device according to claim 18, wherein said creating means is configured to add, to said new routing table entry, a second flag information for encapsulating an arriving second type of traffic of said previous destination address in a packet of said second type of traffic addressed to said new destination address.

22. A router device according to claim 18, wherein said at least one original destination address comprises a Mobile IP home address or a Mobile IP co-located care of address.

23. A router device according to claim 18, said router device being configured to carry said second type of traffic by using a tunneling function of said first type of traffic in networks that do not support said second type of traffic.
